(19) United States
(12) Patent Application Publication
(10) Pub. No.: US 2010/0118929 A1
(43) Pub. Date: May 13, 2010

(54) COMMUNICATION APPARATUS, COMMUNICATION METHOD, COMMUNICATION PROGRAM, AND RECORDING MEDIUM

(76) Inventor: Morgan Hirosuke Miki, Osaka (JP)

Correspondence Address: BIRCH STEWART KOLASCH & BIRCH, PO BOX 747, FALLS CHURCH, VA, 22040-0747, US

(21) Appl. No.: 12/593,598

(22) PCT Filed: Apr. 4, 2008
(86) PCT No.: PCT/JP2008/056747

§ 371 Date: Sep. 28, 2009

(30) Foreign Application Priority Data
Apr. 12, 2007 (JP) 2007-105099

(51) Int. Cl. H04B 17/00

(52) U.S. Cl. 375/224

(57) ABSTRACT

The present invention comprises a communication means 10 that receives a packet; a detection means 20 that detects information, contained in the packet, that is known to both transmitting-side and receiving-side communication apparatuses; a comparison means 30 that compares multiple pieces of the known information detected by the detection means 20; a channel estimation means 40; a demodulation means 60; and a control means 70. In the case where it has been determined, as a result of the comparison performed by the comparison means 30, that the multiple pieces of known information are different, the control means 70 makes a channel estimation start instruction to the channel estimation means 40 and makes a channel estimation packet send request to a communication apparatus that sent the packet via the communication means 10, and the channel estimation means 40 performs channel estimation using the sent channel estimation packet based on the channel estimation start instruction from the control means 70.

### TECHNICAL FIELD

The present invention relates to a communication apparatus, communication method, and communication program that require high-speed channel changes and high-speed channel estimation, and to a recording medium on which the communication program is recorded.

### BACKGROUND ART

FIG. 5 illustrates an example of the structure of a general network for transferring data. In this configuration, a transmitting-side communication apparatus (also called a “transmitting terminal” hereinafter) 1000 transfers data to a receiving-side communication apparatus (also called a “receiving terminal” hereinafter).

<Explanation of QoS>

Demand has recently been increasing for the streaming transfer of large amounts of moving picture data, as with, for example, the MPEG-2 TS (Transport Stream). When transferring this kind of streaming data, it is necessary to perform the communication in real time. In other words, QoS (Quality of Service) frames that make up streaming data are provided with validity periods, and must be transmitted within those validity periods.

FIG. 6 is a diagram schematically illustrating examples of packet sequences when QoS frame transmission succeeds and fails.

In the successful example (the upper half of FIG. 6), the transmission of a frame 5 has failed during the first transmission but has succeeded upon retransmission. The retransmission is performed before the validity period of the frame 5 expired, and thus the transmission of the frame 5 is a success.

However, in the unsuccessful example (the lower half of FIG. 6), the transmission of the frame 5 has failed during both the first transmission and the first retransmission. Furthermore, the validity period of the frame 5 has expired before the second retransmission can be carried out. In this case, the QoS frame 5 that could not be transmitted within the validity period cannot be used and is invalid (that is, the frame is lost), and thus the video resulting from that moving picture data is disrupted at the receiving terminal. Therefore, when performing retransmissions to compensate for transmission errors, it is important to ensure that retransmission is successful within the validity period for each frame.

Although the above descriptions discuss the validity period as a time limit, it should be noted that the validity period is not restricted to time only. For example, an upper limit on the number of retransmissions may be used as well.

<Explanation of HPAV Specification>

Next, an outline of the creation of transmission data according to the PLC (Power Line Communication) HPAV (HomePlug Audio Video) specification shall be given using the HPAV specification format illustrated in FIG. 7.

Like wireless LANs (Local Area Networks), Ethernet, and so on, the HPAV specification is divided into two layers, namely the MAC (Media Access Control) layer and the PHY (physical) layer.

Data is inputted as a stream of frames in the MAC layer. The inputted stream of frames is split up into 512-byte units called segments.

The unit by which data is transferred from the MAC layer to the physical layer is the Long MPDU (MAC Protocol Data Unit), which starts with a 16-byte AVFC (Audio Video Frame Control), followed by n PBs (Physical Blocks). AVFC is a header containing various information concerning the PB. The PB is made up of a header H, a PBB (PB body), and an error check (C). The header H is 4-byte information for the PBB. The PBB, meanwhile, is the content of the segment, but encrypted. C, finally, is a 4-byte error check code for the H and the PBB. Thus, in this example, the PB is 520 bytes, but there are also cases where the PB is 136 bytes. Note that when a frame does not fit perfectly within the segment of the final PB, a PAD is inserted in the leftover space in order to adapt it to the length of the segment.

The Long MPDU is modulated in the PHY layer. First, a signal called a preamble, which is already known by the transmitter and the receiver, is sent. Next, the AVFC is modulated as OFDM (Orthogonal Frequency Division Multiplexing) symbols with a single predetermined modulation accuracy. The following n PBs are modulated as M OFDM symbols, where the number of OFDM symbols depends on the number of PBs and the transmission rate at which the PBs are modulated. OFDM and the transfer rate will be explained next. Furthermore, the preamble is used to identify the Long MPDU, demodulate the AVFC, and so on. Note also that in the present specification, signals handled in the physical layer are called “packets”.

<Explanation of Data Transfer According to Multicarrier System>

Returning to FIG. 5, first, the transmitting terminal 1000 generates and sends a signal to be transmitted (TX). The transmitted TX signal is received by the receiving terminal 1200 via a communication medium (channel) 1100 as an RX signal. In this case, the signal is modified in the channel 1100, and when the transfer function thereof is expressed as H, the relationship shown in the following Equation (1) is established.

RX=TX*H+n (1)

Here, n represents noise.

Recently, the multicarrier systems are frequently used as a system for data transfer. OFDM is one example of such multicarrier systems. FIG. 8 illustrates an example of an OFDM signal. In this diagram, the horizontal axis represents time, the vertical axis represents amplitude, and the third axis (the diagonal axis) represents frequency. OFDM signals are transmitted in units called OFDM symbols. N carriers are allocated to a single OFDM symbol, with each carrier corresponding to a single frequency. Each carrier thus carries one part of the transmitted data.

When data is allocated to each carrier, it is necessary to determine how many bits of data are allocated to that carrier. The method for this will be discussed later, but the carriers may be complex-valued.

FIG. 9 illustrates an example of the modulation accuracy of 16 QAM (Quadrature Amplitude Modulation) where 4 bits are allocated to a single complex-valued carrier. Here, I represents the real part, while Q represents the imaginary part. A total of 4 bits is allocated to the carrier as a whole by allocating 2 bits each to I and Q. In this example, the relationship between the bit value and I or Q is defined as shown in Table 1 below.

TABLE 1

| Bit Value | I or Q |
|---|---|
| 11 | 3 |
| 10 | 1 |
| 00 | −3 |
| 01 | −1 |

There are thus 2⁴=16 options, and all of these options are plotted in FIG. 9.

Here, when transferring, for example, “0010”, “00” is allocated to the real part I and “10” is allocated to the imaginary part Q, and thus the carrier value is −3+j, where j=SQRT(−1). In other words, the I axis value is −3 and the Q axis value is +1.

Data transfer is thus carried out by allocating M bits of data to each carrier (with M=4, in the case of 16 QAM).

Usually OFDM signals are generated in such a way that when the average of the absolute values across the multiple OFDM symbols in the transmitted signal TX is computed, this average of absolute values is constant for each carrier, as shown in FIG. 10. In other words, although there are 16 options in the example of 16 QAM shown in FIG. 9, the average of absolute values is constant no matter what the circumstances are.

Rewriting the above Equation (1) for each carrier results in Equation (2), shown below.

RX(i)=TX(i)*H(i)+n(i) (2)

Here, i expresses the carrier number.

FIG. 11 illustrates an example of the relationship between the transmitted signal TX and the received signal RX that has passed through the channel. When compared to the transmitted signal TX, it can be seen that the RX signal has been modified by the transfer function H.

Signals transmitted from the transmitting terminal thus are not received by the receiving terminal in their original form. It is therefore necessary for the receiving terminal to restore the received signal to its original form in order to correctly demodulate that received signal. For this reason, the receiving terminal normally carries out a channel estimation process for estimating H. The method used for this channel estimation process will be described later, but when the result of the estimation is taken as H′, the receiving terminal uses H′ to perform a channel correction process as illustrated below.

$$\begin{matrix}{TX ( i )}^{′} = 1 / {H}^{′} ( i ) * RX ( i ) \\ = 1 / {H}^{′} ( i ) * ( TX ( i ) * H ( i ) + n ( i ) ) \\ = TX ( i ) + {n}^{′} ( i )\end{matrix} \qquad ( 3 )$$

By performing channel correction in such a manner, the receiving terminal can obtain TX′, which closely resembles the original TX. The closer the estimated H′ is to H, the more closely the reproduced signal will resemble the transmitted signal TX.

FIG. 12(a) illustrates an example in which the effects of noise have been added to the signal RX shown in FIG. 11. Here, the solid line represents the average value of the RX signal (average channel response), whereas the broken lines represent the range of noise. As shown in the diagram, the range of noise is not constant relative to the frequency axis, and in this example, the range is greater in the lower frequencies and lesser in the higher frequencies.

The signal shown in FIG. 12(b), meanwhile, represents the signal TX′ resulting from performing channel correction on the signal RX shown in FIG. 12(a). The solid line represents the average value and the broken line represents the noise range in this case as well. In frequencies where the signal RX has a low amplitude and a high amount of noise (for example, the area of the diagram indicated by an “A”), the amount of noise in TX′ increases, whereas in frequencies where the signal has a high amplitude and a low amount of noise (for example, the area of the diagram indicated by a “B”), the amount of noise in TX′ decreases. Thus, as described thus far, the amount of noise after correction depends on the amplitude and the amount of noise in the original signal RX.

The example of 16 QAM for the signal TX, described above using FIG. 9, assumes no noise, and thus the I and Q carrier values are exactly 3, 1, −1, or −3. However, FIGS. 13a to 13c illustrate examples of 16 QAM for the signal TX taking noise into consideration, with FIG. 13a showing an example where the signal in the receiving terminal has a low amount of noise. Here, the regions of noise in the carrier values are represented by • (areas filled in with black). As shown in FIG. 13a, the individual regions are sufficiently separated from one another when the amount of noise is low, and thus communication can be carried out without a problem.

FIG. 13b, meanwhile, is an example where the amount of noise in the signal in the receiving terminal is near its limit. Although the individual regions are touching one another, communication is possible by performing error correction processing.

However, FIG. 13c is an example where the amount of noise in the signal in the receiving terminal is too great. In this case, large portions of the individual regions are overlapping with adjacent regions, and thus the signal cannot be restored even with error correction processing. In such cases, it is therefore necessary to use a modulation accuracy less than 16 QAM. In this case, QPSK (Quadrature Phase Shift Keying) (equivalent to 4 QAM), or in other words, a modulation accuracy that allocates 2 bits to a single carrier, can be used.

While communication can be performed without problems in the example shown in FIG. 13a, it should be noted that in the next higher level, or 64 QAM, 6 bits can be allocated to a single carrier. In other words, using 16 QAM on this carrier is ultimately a waste of bandwidth.

It is therefore possible to find the optimal modulation accuracy in the receiving terminal by estimating the strength and noise amount of the carrier, or in other words, the SNR (Signal to Noise Ratio). Communication can then be carried out at the fastest possible transmission rate by notifying the transmitting terminal of the SNR.

<Explanation of Method for Estimating Transfer Function H of Channel>

Normally, a signal already known by both the transmitting terminal and the receiving terminal is transmitted in order to estimate the transfer function H. In HPAV, the preamble is the signal known to the transmitter and the receiver, but only one preamble is sent for every Long MPDU. Therefore, HPAV uses a channel estimation packet for channel estimation. The PB of this packet is known to both the transmitting terminal and the receiving terminal, and is constituted by multiple OFDM symbols. Because multiple OFDM symbols are used for a single Long MPDU, channel estimation can be carried out more efficiently than when using the preamble. This will be described hereinafter.

When X(i) is taken as the OFDM symbol of the channel estimation packet transmitted by the transmitting terminal, the following holds true in the receiving terminal.

Y(i)=X(i)*H(i)+n(i)

Because the receiving terminal knows that the content received is X, it can find Hxy(i) through, for example, the following calculations.

$$\begin{matrix}Hxy ( i ) = Y ( i ) / X ( i ) \\ = ( X ( i ) * H ( i ) + n ( i ) ) / X ( i ) \\ = H ( i ) + {n}^{′} ( i )\end{matrix} \qquad ( 4 )$$

Of primary importance here is reducing the effects of n′. Therefore, normally, the transmitting terminal transmits multiple X(i), and the receiving terminal finds the estimated value H′(i) based on, for example, the average of multiple Hxy(i). Similarly, the amount of noise may be taken to be the standard deviation of Hxy(i).

The above Equation (4) is a conventionally-known high-speed LS (Least Square) algorithm for estimating channel amplitude. Although using this LS algorithm does enable channel estimation within the QoS period, the algorithm has, in reality, not often been implemented.

On the other hand, LMS (Least Mean Square) is an easily-implementable algorithm often used conventionally, but because the processing of this algorithm requires several seconds to complete, it cannot perform the channel estimation within the QoS period.

Incidentally, the transfer function H differs between the transmitting terminal and the receiving terminal. That is, H between a transmitting terminal 1 and a receiving terminal 2 is different from H between a different transmitting terminal 3 and the receiving terminal 2. It is therefore necessary to identify which terminal transmitted the data when performing channel correction using the abovementioned method. For this reason, in HPAV, the AVFC portion is transmitted by QPSK, which has a low, safe modulation accuracy. As a result, the AVFC can be properly demodulated even after channel estimation using the preamble. Furthermore, demodulating the AVFC makes it possible to understand in what way the channel correction on the PB portion (assuming channel estimation has ended) and demodulation of the PB portion should be carried out, making it possible to demodulate the PB using the more efficient Hxy (Hxy in Equation (4), explained above).

DSL (Digital Subscriber Line) and PLC are examples of systems by which the SNR is estimated by the receiving terminal, as described above.

Note that when a change occurs in a channel, a change also occurs in the transfer function H. Assuming that H1 represents pre-change and H2 represents post-change, prior to the change, channel estimation/correction suited to H1 is performed, and a modulation accuracy that is optimal for H1 is used. However, when the channel changes to H2, data cannot be transmitted by H2 using the optimal conditions for H1. In other words, when the modulation accuracy found in a state prior to the change in the channel is used in the modulation of data after the channel has changed, the data error rate in the receiving terminal may increase, particularly when the change in the channel is great.

With DSL, the channel conditions experience almost no change, and thus the process for estimating the SNR is usually only performed once, when starting up the terminal. Since this process is only performed once, a simple and time-consuming method is used for DSL. A change in the DSL channel is equivalent to a change in the amount of noise, and the change is gradual (see, for example, Patent Document 1), and therefore proper adjustments can be made before the error rate increases.

Regarding PLC, in, for example, Non-Patent Document 1, the SNR is estimated through the method used for conventional DSL, which assumes that the channel experiences almost no change. Non-Patent Document 2, meanwhile, does not use the DSL method, but nevertheless assumes that the channel experiences almost no change.

However, PLC is different from DSL in that it is affected by the various devices connected to the power line. For example, when a household appliance is connected to the power line, the channel amplitude and noise characteristics change dramatically. Although there are conventional techniques for identifying this channel change (see Non-Patent Document 3), that document does not clearly discuss the method for the analysis thereof and the effects of channels that change dramatically. PLC has been used conventionally in Internet communications. Specifically, PLC has been used when reading emails and browsing web pages, and thus a break in communication of several seconds has not been a problem. However, with video QoS, the period of each QoS frame is 100 to 200 ms. Furthermore, in the case of VoIP (Voice Over Internet Protocol), used for audio such as telephony, this period is less than or equal to 100 ms. Therefore, in PLC, even when a channel changes dramatically, it is necessary to identify the change in the channel, and estimate the amplitude and noise of the channel within the QoS period. In this case, monitoring the error rate of, for example, frames and PBs and identifying the channel as having changed when that error rate has increased is an example of a method for quickly identifying changes in channel conditions.

### [Patent Document 1] JP 2005-278150A

[Non-Patent Document 1] S. Morosi, D. Marabissi, E. Del Re, R. Fantacci, N. Del Santo: “A rate adaptive bit-loading algorithm for a DMT modulation system for in-building power-line communications”, in Global Telecommunications Conference, 2005. GLOBECOM '05. IEEE, November/December 2005, Vol 1, pp. 403-407.
[Non-Patent Document 2] D. Anastasiadou and T. Antonakopoulos: “Broadband communications in the indoor power line environment: The pDSL concept”, in Proc. ISPLC '04, Zaragoza, Spain, March 2004, pp. 334-339.
[Non-Patent Document 3] E. Biglieri: “Coding and modulation for a horrible channel”, in Communications Magazine, IEEE, May 2003, Vol 41, Issue 5, pp 92-98.

### DISCLOSURE OF THE INVENTION

### Problem to be Solved by the Invention

However, a change in the channel is not necessarily the cause of errors in frames and PBs. An increase in the error rate is therefore not necessarily tied solely to change in the channel. Thus, when employing the method that identifies changes in a channel based on the error rate of frames and PBs, false identifications may be more likely to occur, and the time used in channel estimation may be wasted.

Furthermore, multiple frames or PBs are necessary in order to find the error rate. With video, because the transmission rate is high, the number of PBs is high as well, and multiple PBs are sent in a small amount of time; this makes it possible to find the error rate in a short amount of time. However, with, for example, the G.723.1 audio codec, the maximum audio rate is 64 Kbps, or less than or equal to 1 Kbyte per second. Normally, for problem-free transmission, it is preferable to have an error rate of 0.01 or less, and it is desirable to switch transmission speeds when the error rate exceeds 0.1. 10 frames or PBs are necessary to identify an error rate of 0.1. Therefore, there is a problem in that when the transmission rate reaches 1 Kbyte per second, finding the error rate will cause the QoS period to be exceeded. While this can be solved by setting the amount of data allocated to a single Long MPDU at several bytes, doing so is problematic in that it wastes bandwidth. It is therefore necessary to identify changes in channels using a different method.

The present invention has been conceived in order to solve these problems, and it is an object thereof to provide a communication apparatus, communication method, communication program, and recording medium capable of identifying a change in the channel and estimating the channel within the QoS period without wasting bandwidth.

### Means to Solve the Problems

In order to solve the stated problems, a communication apparatus of the present invention comprises a communication means that at least receives a packet; a detection means that detects information, contained in the packet, that is known to both transmitting-side and receiving-side communication apparatuses; a comparison means that compares multiple pieces of the known information detected by the detection means; and a channel estimation means, wherein a channel estimation start instruction is given to the channel estimation means based on a result of the comparison performed by the comparison means.

In this communication apparatus of the present invention, a channel estimation start instruction is made in the case where the comparison means has determined that the multiple pieces of known information are different.

Furthermore, a communication apparatus of the present invention comprises a communication means that sends and receives a packet; a detection means that detects information, contained in the packet, that is known to both transmitting-side and receiving-side communication apparatuses; a comparison means that compares multiple pieces of the known information detected by the detection means; and a channel estimation means, wherein, based on a result of the comparison performed by the comparison means, a channel estimation packet send request is given to a communication apparatus that sent the packet via the communication means and a channel estimation start instruction is given to the channel estimation means.

In this communication apparatus of the present invention, the channel estimation packet send request is given and the channel estimation start instruction is given in the case where the comparison means has determined that the multiple pieces of known information are different.

According to such a configuration, the comparison means determines whether or not the multiple pieces of information known to both the transmitting-side and receiving-side communication apparatuses are different, or in other words, whether or not the channel has changed. To be more specific, with the PLC HPAV specification, the preambles, which are known to both the transmitting-side and receiving-side communication apparatuses, are compared. In other words, for example, two preambles contained in two adjacent frames that have been transmitted are compared in sequence, and it is determined whether or not the information in the preambles differs. The channel is determined to have changed when the informations in the preambles are different. According to this method, it is possible to identify (determine) a change in the channel with more certainty than the conventional method of identifying a change in the channel based on a change in the error rate. Furthermore, with low-transmission rate data such as audio, a change in the channel can be identified more quickly, and combining this with high-speed channel estimation makes it possible to identify a change in the channel and estimate the channel without wasting bandwidth.

Furthermore, according to the communication apparatus of the present invention, the comparison means may determine that the multiple pieces of known information are different in the case where total of absolute values of differences between the multiple pieces of known information for each carrier is greater than a pre-set reference threshold.

Alternatively, according to the communication apparatus of the present invention, the comparison means may determine that the multiple pieces of known information are different in the case where an absolute value of differences between the multiple pieces of known information in each of an arbitrary number of carriers is greater than a pre-set reference threshold.

Furthermore, according to the communication apparatus of the present invention, the channel estimation means performs channel estimation using the channel estimation packet that has been sent. Performing channel estimation using the channel estimation packet makes it possible to perform more highly-accurate channel estimation.

Furthermore, the communication apparatus of the present invention further comprises an identification means that identifies a communication apparatus that sent the packet, where the comparison means compares the multiple pieces of known information sent by the same communication apparatus based on a result of the identification performed by the identification means. In other words, the multiple pieces of known information sent by the same communication apparatus are compared by identifying the communication apparatus that sent the packet. Channel conditions differ for each communication apparatus. Therefore, using the communication apparatus of the present invention makes it possible to compare the multiple pieces of known information sent by the same communication apparatus even if there are two or more communication apparatuses in the system that composes the network, and it is thus possible to prevent mistaken determinations of channel changes.

Here, the identification method used by the identification means may be configured so that the transmitting communication apparatus is identified based on a transmitting terminal identifier contained in the packet. The transmitting terminal can be identified with certainty by identifying the transmitting terminal using a terminal identifier.

Furthermore, the identification method used by the identification means may also be configured so that, in the case where the communication means carries out communication using a cyclical channel access method, the identification means identifies packets received in the same time slot of the cycle as packets sent by the same communication apparatus. In other words, packets received in the same time slot of a cycle are identified as having been transmitted by the same communication apparatus, and therefore the transmitting terminal can be identified as soon as packets start being received, enabling faster identification.

Furthermore, a communication method of the present invention is a communication method for a receiving-side communication apparatus in a communication system that sends multiple packets from a transmitting-side communication apparatus to the receiving-side communication apparatus using multiple communication channels, and the method comprises a detection step of detecting information, contained in the packet, that is known to both of the communication apparatuses; a comparison step of comparing multiple pieces of the known information detected in the detection step; and a step of giving a channel estimation start instruction to a channel estimation means based on a result of the comparison performed in the comparison step.

Furthermore, a communication method of the present invention is a communication method for a receiving-side communication apparatus in a communication system that sends multiple packets from a transmitting-side communication apparatus to the receiving-side communication apparatus using multiple communication channels, and the method comprises a detection step of detecting information, contained in the packet, that is known to both of the communication apparatuses; a comparison step of comparing multiple pieces of the known information detected in the detection step; a step of giving a channel estimation packet send request to a transmitting-side communication apparatus that sent the packet in the case where it has been determined that the multiple pieces of known information are different as a result of the comparison performed in the comparison step; and a step of giving a channel estimation start instruction to a channel estimation means, wherein the channel estimation means performs channel estimation using the channel estimation packet sent from the transmitting-side communication apparatus.

According to such a configuration, it is determined whether or not the multiple pieces of information known to both the transmitting-side and receiving-side communication apparatuses are different, or in other words, whether or not the channel has changed. To be more specific, with the PLC HPAV specification, the preambles, which are known to both the transmitting-side and receiving-side communication apparatuses, are compared. Therefore, it is possible to identify (determine) a change in the channel with more certainty than the conventional method of identifying a change in the channel based on a change in the error rate. Furthermore, with low-transmission rate data such as audio, a change in the channel can be identified more quickly, and combining this with high-speed channel estimation makes it possible to identify a change in the channel and estimate the channel without wasting bandwidth. Furthermore, the configuration is such that in the channel estimation performed by the channel estimation means, the channel estimation is performed using the transmitted channel estimation packet. Performing channel estimation using the channel estimation packet makes it possible to perform more highly-accurate channel estimation.

Furthermore, the communication method of the present invention further comprises an identification step that identifies the transmitting-side communication apparatus that sent the packet, wherein the comparison step compares the multiple pieces of known information sent by the same communication apparatus based on a result of the identification performed in the identification step. Channel conditions differ for each communication apparatus. Therefore, using the communication method of the present invention makes it possible to compare the multiple pieces of known information sent by the same communication apparatus even if there are two or more communication apparatuses in the system that composes the network, and it is thus possible to prevent mistaken determinations of channel changes.

Furthermore, according to the communication method of the present invention, the identification step identifies a transmitting communication apparatus based on a transmitting terminal identifier contained in the packet. The transmitting terminal can thus be identified with certainty by identifying the transmitting terminal using a terminal identifier.

Furthermore, according to the communication method of the present invention, in the case where the communication method carries out communication using a cyclical channel access method, the identification step identifies packets received in the same time slot of the cycle as packets sent by the same communication apparatus. In other words, packets received in the same time slot of a cycle are identified as having been transmitted by the same communication apparatus, and therefore the transmitting terminal can be identified as soon as packets start being received, enabling faster identification.

Furthermore, the stated communication method may be provided as a communication program that causes a computer to execute the steps thereof, and that communication program may be recorded on a computer-readable recording medium and provided.

### EFFECTS OF THE INVENTION

Being configured as described above, the present invention is capable of determining a change in the channel with more certainty than the conventional method of identifying a change in the channel based on a change in the error rate. Furthermore, with low-transmission rate data such as audio, a change in the channel can be identified more quickly, and combining this with high-speed channel estimation makes it possible to identify a change in the channel and estimate the channel within the QoS period without wasting bandwidth.

### BRIEF DESCRIPTION OF DRAWINGS

FIG. 1 is a block diagram illustrating the configuration of the main elements of a communication apparatus according to a first embodiment of the present invention.

FIG. 2 is a flowchart illustrating the flow of processing in a communication method (specifically, a channel estimation process) performed by the communication apparatus of the first embodiment.

FIG. 3 is a block diagram illustrating the configuration of the main elements of a communication apparatus according to a second embodiment of the present invention.

FIG. 4 is a flowchart illustrating the flow of processing in a communication method (specifically, a channel estimation process) performed by the communication apparatus of the second embodiment.

FIG. 5 is an explanatory diagram illustrating an example of a general network configuration for performing data transfer.

FIG. 6 is an explanatory diagram schematically illustrating examples of packet sequences when QoS frame transmission succeeds and when QoS frame transmission fails.

FIG. 7 is an explanatory diagram illustrating the format of the HPAV specification.

FIG. 8 is an explanatory diagram illustrating an example of an OFDM signal.

FIG. 9 is an explanatory diagram illustrating an example of the modulation accuracy of 16 QAM where 4 bits are allocated to a single complex-valued carrier.

FIG. 10 is an explanatory diagram illustrating a signal waveform when the average of absolute values across the multiple OFDM symbols in a transmitted signal TX is found.

FIG. 11 is an explanatory diagram illustrating an example of the relationship between the transmitted signal TX and a received signal RX that has passed through the channel.

FIG. 12 is an explanatory diagram illustrating an example in which the effects of noise have been added to the signal RX shown in FIG. 11.

FIG. 13a is an explanatory diagram illustrating an example of 16 QAM for the signal TX taking noise into consideration.

FIG. 13b is an explanatory diagram illustrating an example of 16 QAM for the signal TX taking noise into consideration.

FIG. 13c is an explanatory diagram illustrating an example of 16 QAM for the signal TX taking noise into consideration.

### DESCRIPTION OF REFERENCE NUMERALS

10 communication means
20 detection means
30 comparison means
40 channel estimation means
50 identification means
60 demodulation means
70 control means

### BEST MODE FOR CARRYING OUT THE INVENTION

Embodiments of the present invention shall now be described with reference to the drawings.

### First Embodiment

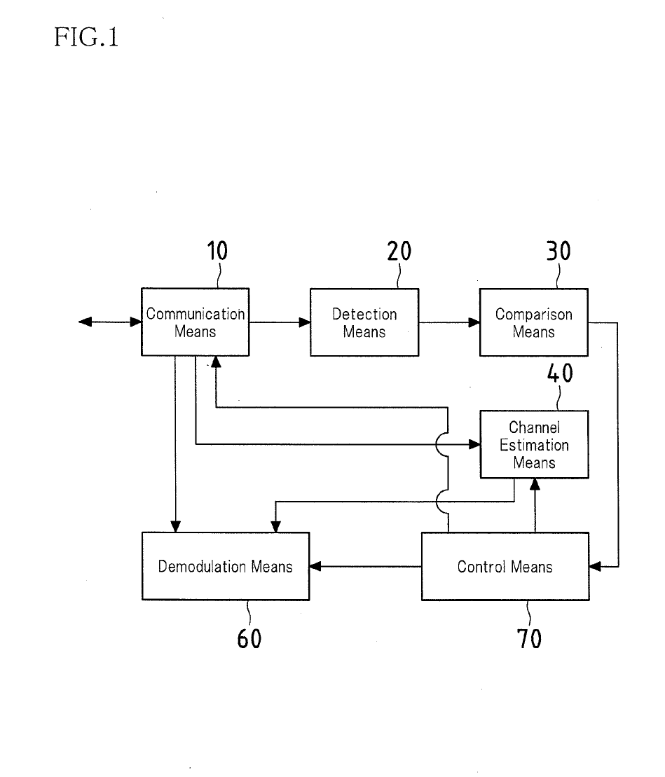

FIG. 1 is a block diagram illustrating the configuration of the main elements of a communication apparatus according to the first embodiment.

In this diagram, the communication apparatus of the present first embodiment includes a communication means 10, a detection means 20, a comparison means 30, a channel estimation means 40, a demodulation means 60 that demodulates a transmitted signal TX into a signal RX (received data), and a control means 70 that performs overall communication control. Note that because data communication is performed between a communication apparatus on the transmitting side and a communication apparatus on the receiving side, the communication apparatus of the present first embodiment can be applied as both the communication apparatus on the transmitting side and the communication apparatus on the receiving side. However, for explanatory purposes, the descriptions here assume that the communication apparatus of the present first embodiment is applied in the communication apparatus on the receiving side (a receiving terminal).

The communication means 10 is an element that transmits and receives frames. Although the meaning of “communication means” depends on the configuration of the apparatus, the communication means 10 discussed here refers to all portions in the normal MAC/PHY layers aside from the detection means 20, comparison means 30, channel estimation means 40, demodulation means 60, and control means 70. This corresponds to, for example, the analog portion, or in the case of OFDM, the portion that performs an FFT (Fast Fourier Transform) and an Inverse FFT for converting a signal in the frequency axis into a signal in the time axis.

The detection means 20 is an element that detects information already known to both the transmitter and the receiver. With HPAV, this known information is the preamble or an OFDM symbol for channel estimation. Because normal data does not contain an OFDM symbol for channel estimation, the preamble is used as the known information in the present first embodiment. Note, however, that this information is not actually limited to the preamble, and any information may be used for comparison by the comparison means 30 as long as that information is already known by both the transmitter and the receiver.

The comparison means 30 is an element that compares the preambles of multiple packets (Long MPDUs). The comparison means 30 compares multiple preambles and outputs the result of that comparison to the control means 70. Based on the result of the comparison performed by the comparison means 30, the control means 70 outputs an instruction signal instructing the channel estimation means 40 to start channel estimation. Upon receiving this instruction signal, the channel estimation means 40 starts a channel estimation process.

When the channel conditions change, the information thereof is reflected in the preamble. Therefore, in the present embodiment, the basis for the judgment performed by the comparison means 30 is whether or not the preamble is different across multiple packets. For example, a channel can be identified as having changed when two packets have different preambles.

To describe this in more detail, for example, the method for comparison calculates the total of the absolute values of the differences between the multiple preambles for each carrier and determines that the channel has changed when the total value is greater than a reference threshold set in advance. The channel may also be determined as having changed when the absolute value of the difference among m carriers (where m is any number) has exceeded a reference threshold set in advance. Note that the absolute difference may be logarithmic. Furthermore, the carrier information in the preamble used in the calculation may be the amplitude, noise, or phase of each carrier, or the SNR of each carrier. The preamble characteristics can be used because the amplitude or noise is found from the HPAV preamble. The HPAV preamble is constituted by at least 8 set patterns that repeat temporally. Some of these patterns are used in AGC (Automatic Gain Control) and packet identification, but the amplitude, noise, or SNR can be found using the statistical information of the remainder of those patterns.

The comparison means 30 can therefore identify a change in channel conditions using the preamble, and can thus request the transmitting terminal to transmit a channel estimation packet.

In other words, the present first embodiment has a configuration whereby the transmitting terminal transmits a channel estimation packet to the receiving terminal in order to perform channel estimation. Accordingly, when the comparison means 30 has determined through the stated determination process that channel estimation is necessary, a packet containing information requesting the channel estimation packet is transmitted to the transmitting terminal via the communication means 10. Upon receiving this information, the transmitting terminal transmits the channel estimation packet to the transmitting terminal (in other words, the terminal that transmitted the packet containing the request information).

Upon receiving, from the comparison means 30, the instruction signal instructing channel estimation to be started, and receiving, via the communication means 10, the channel estimation packet transmitted by the transmitting terminal, the channel estimation means 40 performs the channel estimation process using the received channel estimation packet. Because this channel estimation process is a conventionally-known process, detailed descriptions thereof shall be omitted here; note, however, that the amplitude and noise of the channel may be estimated at the same time in order to expedite the channel estimation process.

Note also that because the optimal modulation accuracy for each carrier is found through the channel estimation, the receiving terminal transmits that information to the transmitting terminal. The transmitting terminal modulates data using this information and transmits the modulated data to the receiving terminal.

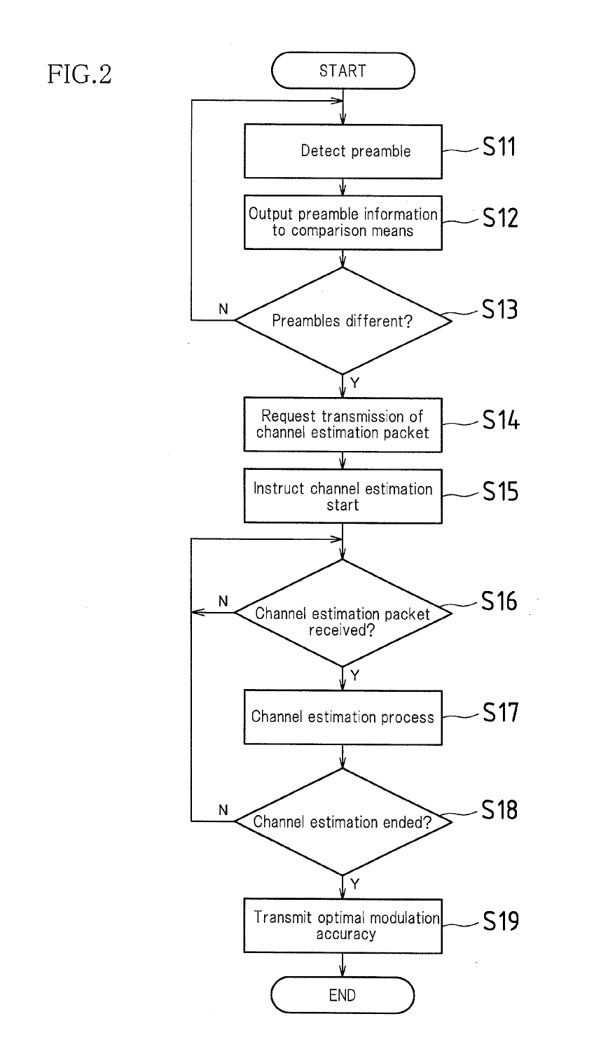

Next, the processing flow of the communication method performed by the communication apparatus of the present first embodiment (specifically, the channel estimation process) will be described once more with reference to the flowchart illustrated in FIG. 2.

During data communication, the detection means 20 of the receiving terminal detects the preamble, which is known by both terminals, from a packet, which is communication data received via the communication means 10 (step S11). When the preamble has been detected (step S11), the information of the detected preamble is outputted to the comparison means 30 (step S12). The comparison means 30 then determines whether or not the information in multiple inputted preambles differs (step S13). More specifically, two preambles contained in two adjacent frames in the transmitted data are compared in sequence, and it is determined whether or not the information in the preambles differs. If the result indicates that the information in the preambles is identical (when the determination is “No” in step S13), the process returns to step S11. In other words, in this case, the data receiving process is simply continued.

However, if the information in the preambles is different (when the determination is “Yes” in step S13), it is determined that the channel, which is the communication medium, has changed, and that determination result is outputted to the control means 70. Based on this determination result, the control means 70 requests the transmitting terminal, from which the data (packet) was sent, to send a channel estimation packet (step S14). The control means 70 also instructs the channel estimation means 40 to start channel estimation (step S15).

Thereafter, when a channel estimation packet is sent from the transmitting terminal, that channel estimation packet is inputted into the channel estimation means 40 via the communication means 10. When the channel estimation means 40 receives a channel estimation packet after being instructed by the control means 70 to start channel estimation (when the determination is “Yes” in step S16), the channel estimation means 40 performs the channel estimation process using the received channel estimation packet (step S17). Note that the channel estimation process is performed based on statistics of multiple channel estimation packets, and the receiving terminal determines whether or not the channel estimation process has ended. Although this determination falls outside the scope of the present invention, it is determined, in step S18, whether or not the channel estimation process has ended, after performing the channel estimation process for a single channel estimation packet. The process returns to step S16 if the channel estimation process has not ended (that is, when the determination is “No” in step S18). If, however, the channel estimation process has ended (when the determination is “Yes” in step S18), the information of the optimal modulation accuracy that has been found is transmitted from the receiving terminal to the transmitting terminal (step S19). Although the example in this flowchart is an example of the comparison of two preambles, it should be noted that it is also possible to compare two or more preambles.

(Comparison of Channel Estimation Process of Present First Embodiment with Conventional Channel Estimation Process)

As described above, when a channel changes, a change occurs in the preamble signal received by the transmitting terminal. To rephrase, the form of the preamble can be modified by the transmitting terminal as if the channel itself was modified, even if the channel has not changed. In other words, the preamble and AVFC can be modified in the same manner instead of just the preamble, and the signal can be generated without modifying the OFDM symbols in the PB portion that follows the preamble and AVFC.

In this case, when using the channel estimation of the present first embodiment, the receiving terminal identifies a change in the channel based on the preamble, and requests a channel estimation packet from the transmitting terminal. As opposed to this, when the same operation is performed in the conventional method, which checks the error rate, the preamble and AVFC are modified in the same manner; thus the AVFC is demodulated without a problem, and the PB, which has not been modified based on the AVFC information, can also be demodulated without a problem. As a result, with the method that checks the error rate, the channel is determined not to have changed. Thus when only the preamble and AVFC are modified by the transmitting terminal, the method that checks the error rate does not identify a change in the channel. However, in the present first embodiment, a channel estimation packet is requested. Note that when the preamble and AVFC are modified, it is desirable for them to be modified in a manner that allows the comparison means 30 to identify a significant change in the channel.

### Second Embodiment

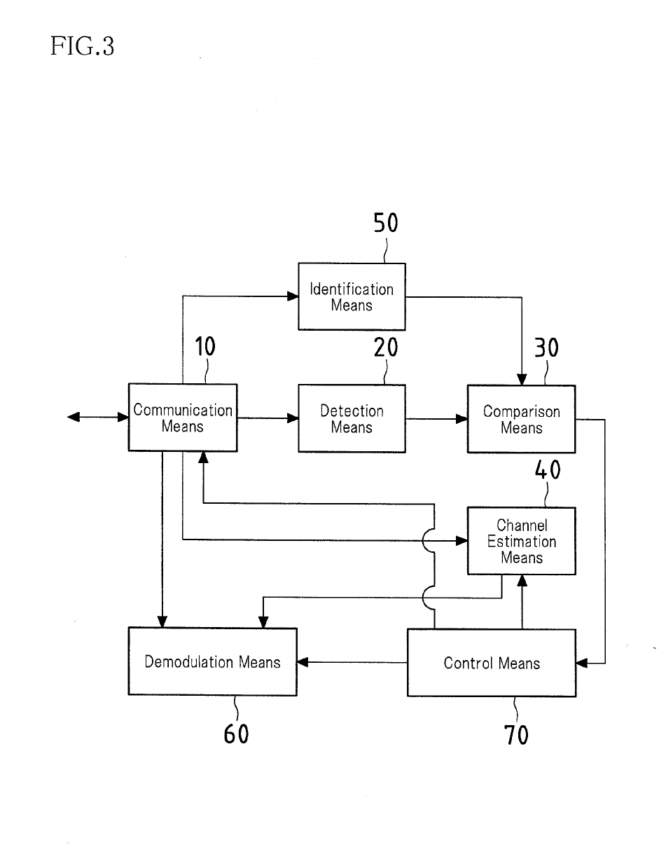

When data is communicated between only two terminals, it is not necessary for the comparison means 30 to identify which terminal has transmitted the data. However, when data is communicated between multiple terminals, it is necessary for the receiving terminal to perform comparison using the preambles transmitted by the same transmitting terminal only. In other words, it is necessary to identify which transmitting terminal transmitted the data. This is because the channel conditions differ for each terminal. Therefore, in the present second embodiment, an identification means 50 is further provided, as shown in FIG. 3. The other elements of the configuration are the same as with the receiving terminal of the first embodiment shown in FIG. 1.

The identification means 50 identifies which transmitting terminal transmitted a packet, and outputs the result of that identification to the comparison means 30. The comparison means 30 identifies which transmitting terminal the preamble received from the detection means 20 belongs to based on the identification result received from the identification means 50. The comparison means 30 can therefore compare two preambles transmitted from the same transmitting terminal, which makes it possible to prevent mistaken determinations of channel changes.

Note that identifying the transmitting terminal based on a transmitting terminal identifier (for example, a MAC address) contained in the packet may be employed as the identification method used by the identification means 50. The transmitting terminal can be identified with certainty by identifying the transmitting terminal using a terminal identifier.

HPAV uses TDMA (Time Division Multiple Access) as its channel access method. In addition, with HPAV, the data communication cycle is twice the power cycle of the power line (50 or 60 Hz). That is, the TDMA cycle is 25 or 30 Hz. Furthermore, the portion of this cycle in which the data transmission between two terminals is performed is pre-set. Therefore, the identification means 50 can determine that data transmitted in an allocated time slot within the TDMA cycle is data transmitted by the same transmitting terminal. In other words, data (packets) received in the same time slot of a cycle are identified as packets transmitted by the same transmitting terminal, and therefore the transmitting terminal can be identified as soon as packets start being received, enabling faster identification.

Although channels do not change dramatically in DSL, they do change little by little, and thus an algorithm used in DSL channel estimation can handle this change. Channels may also change little by little in PLC, and thus by combining an LS algorithm with an algorithm used in DSL, it is possible to handle both dramatic changes and changes that occur little by little in channels.

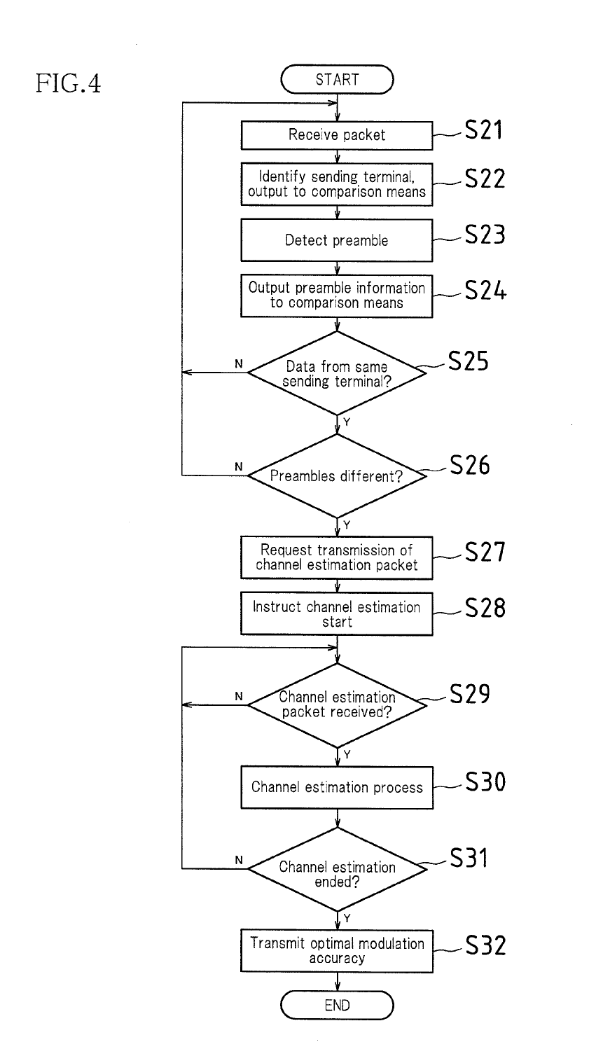

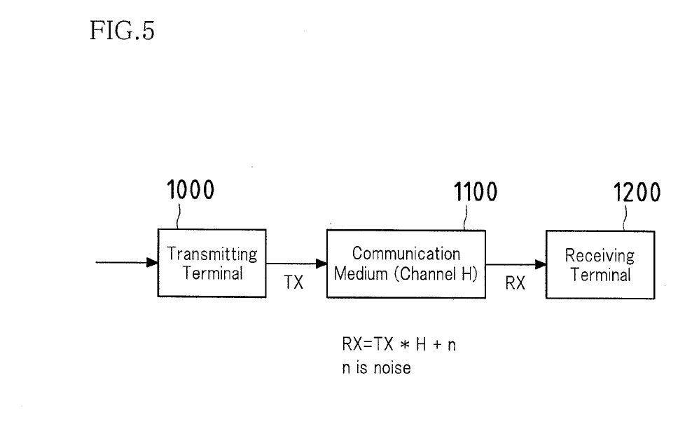

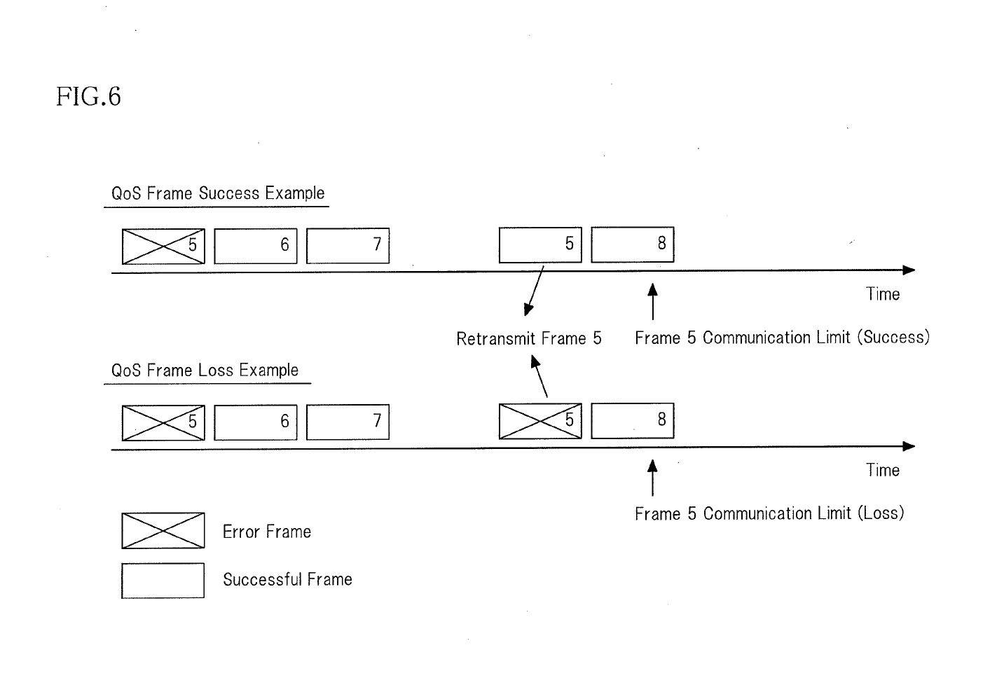

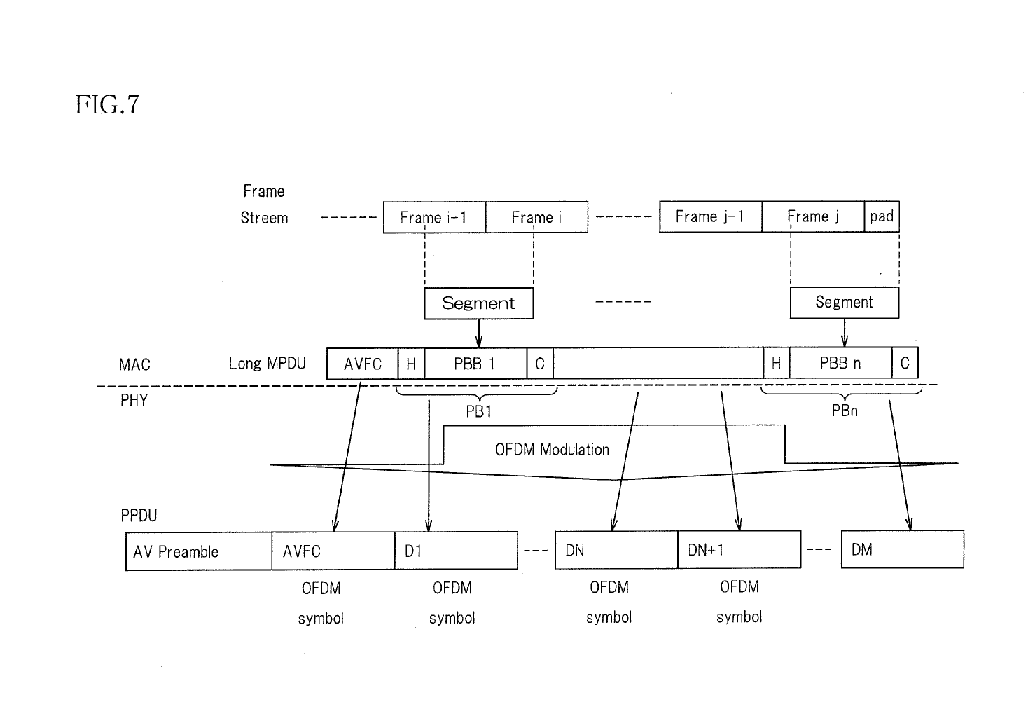

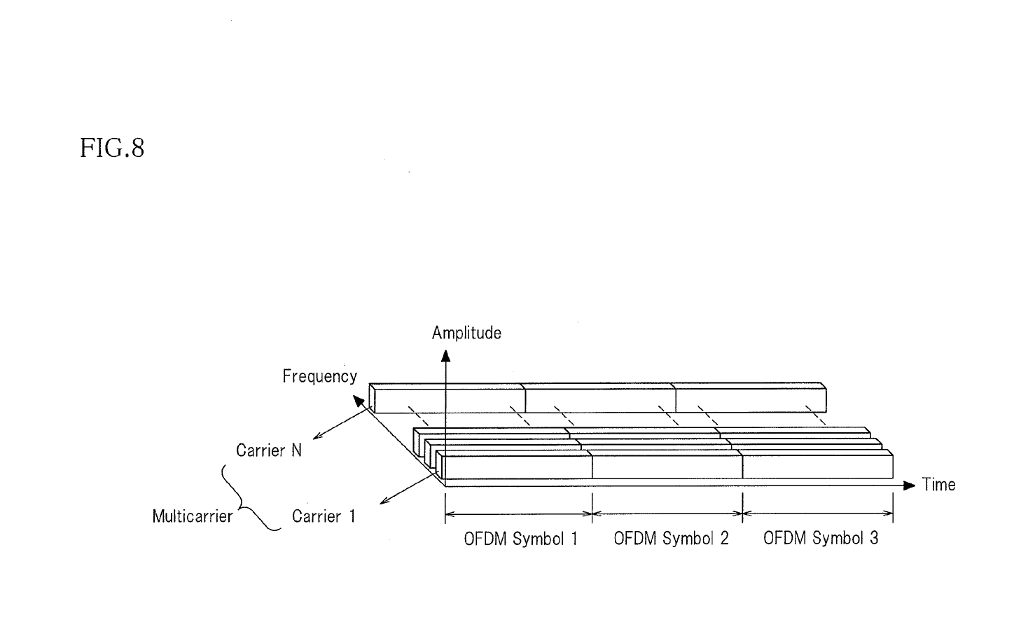

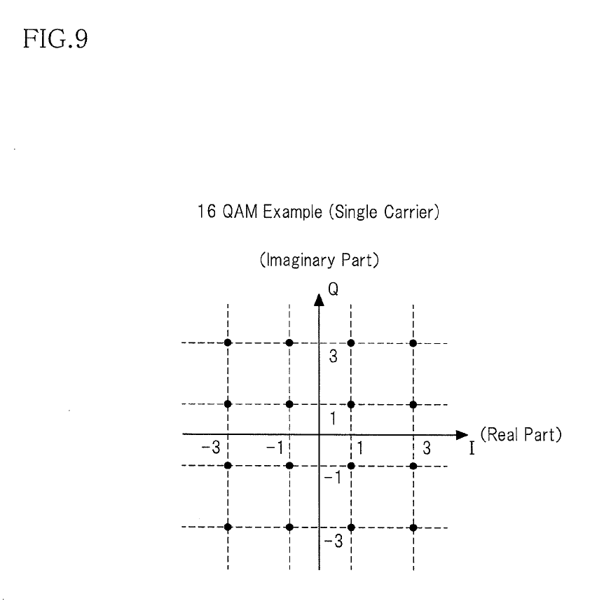

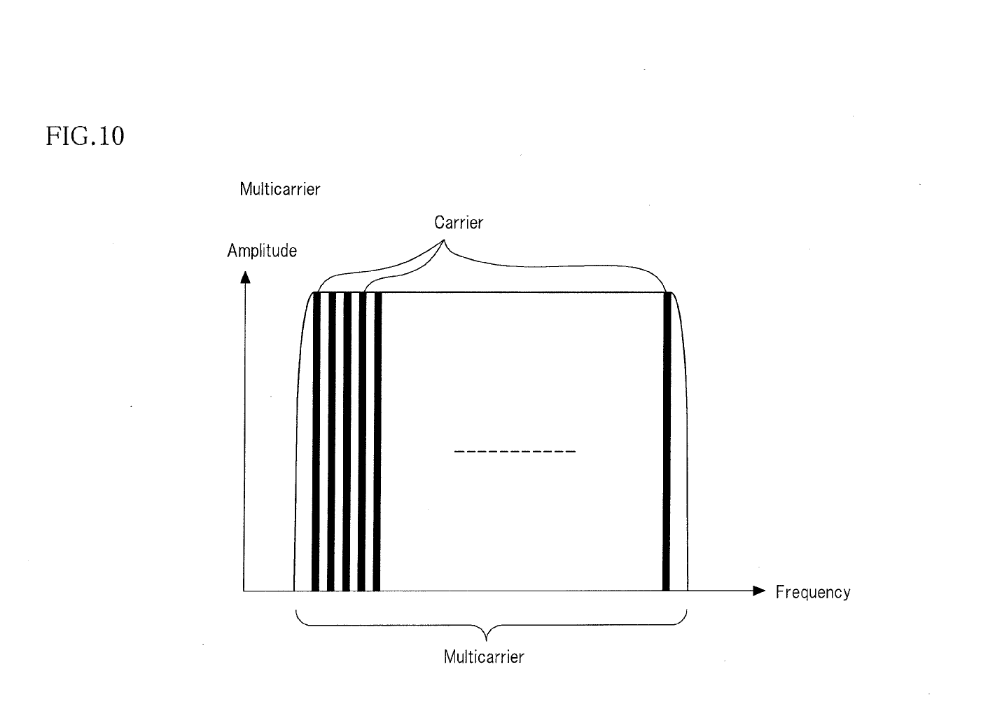

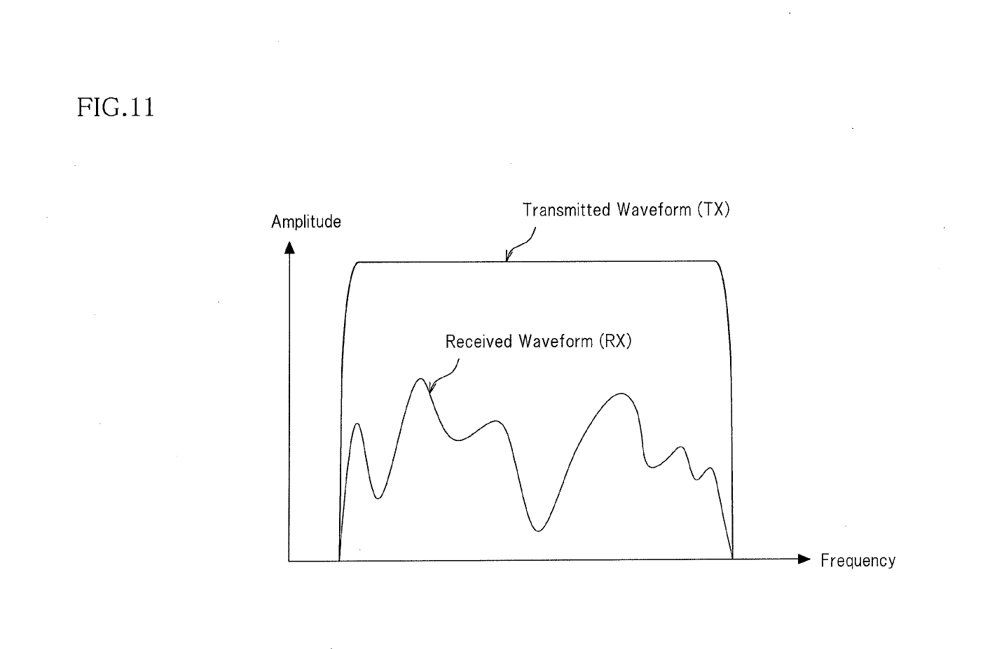

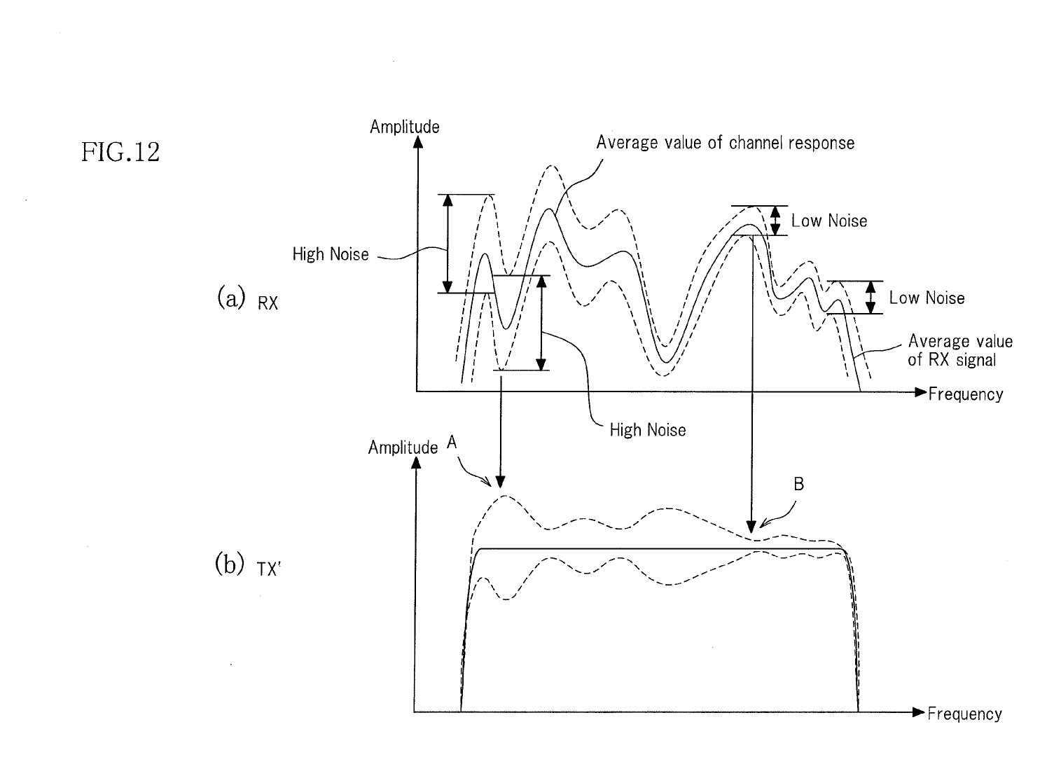

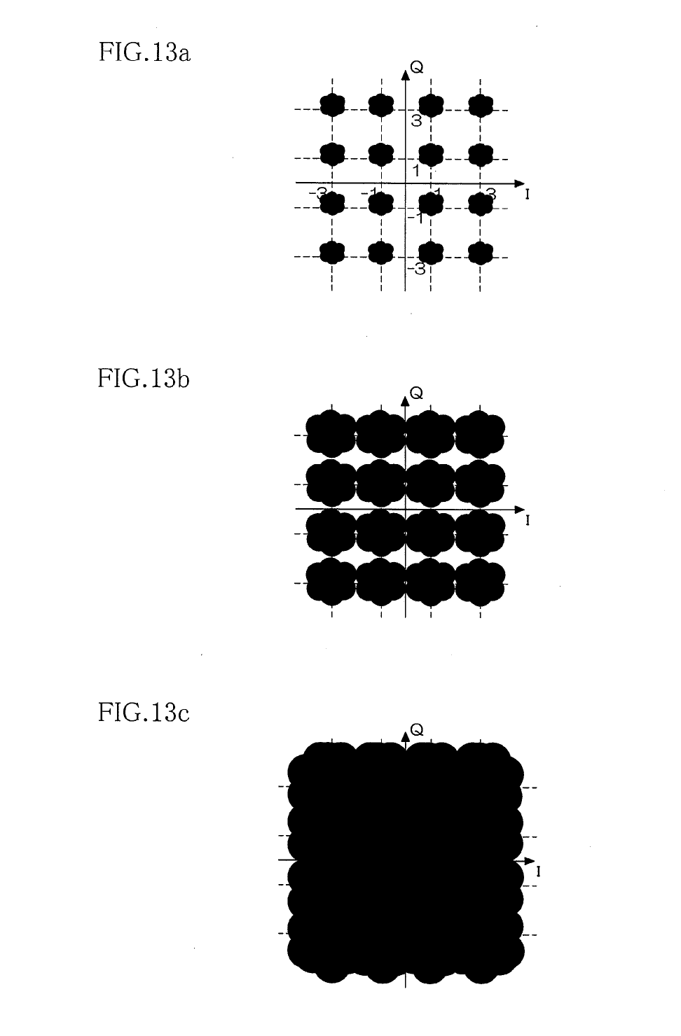

Next, the processing flow of the communication method performed by the communication apparatus of the present second embodiment (specifically, the channel estimation process) shall be described with reference to the flowchart illustrated in FIG. 4.

During data communication, when a packet, which is communication data, is received from the transmitting terminal via the communication means 10 (step S21), the identification means 50 of the receiving terminal identifies which transmitting terminal transmitted the packet based on, for example, a transmitting terminal identifier (a MAC address or the like) contained in the packet, which is the received communication data, and then outputs the result of that identification (a result of identifying whether or not it is the same transmitting terminal) to the comparison means 30 (step S22).

Meanwhile, the detection means 20 of the receiving terminal detects the preamble, which is known by both terminals, from the packet, which is communication data, received via the communication means 10 (step S23), and outputs the information of the detected preamble to the comparison means 30 (step S24).

The comparison means 30 identifies which transmitting terminal the preamble received from the detection means 20 belongs to based on the result of the identification received from the identification means 50. When, as a result, it is determined that the communication data (packet) transmitted the previous time and the communication data (packet) transmitted this time were transmitted by different transmitting terminals (when the determination is “No” in step S25), the process returns to step S21 without performing any actions. In other words, in this case, the received communication data (packet) is ignored.

However, when it is determined that the communication data (packet) transmitted the previous time and the communication data (packet) transmitted this time were transmitted by the same transmitting terminal (when the determination is “Yes” in step S25), the comparison means 30 compares the preamble contained in the packet transmitted the previous time with the preamble contained in the packet transmitted this time (step S26). If the result indicates that the information in the preambles is identical (when the determination is “No” in step S26), the process returns to step S21. In other words, both pieces of communication data (packets) have been transmitted using the same communication medium (channel), and thus in this case, the data receiving process is simply continued.

However, if the information in the preambles is different (when the determination is “Yes” in step S26), it is determined that the channel has changed, and that determination result is outputted to the control means 70. Based on this determination result, the control means 70 requests the transmitting terminal, from which the communication data (packet) was sent, to send a channel estimation packet (step S27). The control means 70 also instructs the channel estimation means 40 to start channel estimation (step S28).

Thereafter, when a channel estimation packet is sent from the transmitting terminal, that channel estimation packet is inputted into the channel estimation means 40 via the communication means 10. When the channel estimation means 40 receives a channel estimation packet after being instructed by the control means 70 to start channel estimation (when the determination is “Yes” in step S29), the channel estimation means 40 performs the channel estimation process using the received channel estimation packet (step S30). Note that the channel estimation process is performed based on statistics of multiple channel estimation packets, and the receiving terminal determines whether or not the channel estimation process has ended. Although this determination is outside the scope of the present invention, it is determined, in step S31, whether or not the channel estimation process has ended, after performing the channel estimation process for a single channel estimation packet. The process returns to step S29 if the channel estimation process has not ended (that is, when the determination is “No” in step S31). If, however, the channel estimation process has ended (when the determination is “Yes” in step S31), the information of the optimal modulation accuracy that has been found is transmitted from the receiving terminal to the transmitting terminal (step S32). Although the example in this flowchart discusses the comparison of two preambles, it should be noted that multiple, i.e. two or more, preambles may be compared.

Although the above embodiments have been described based on the HPAV specification, it should be noted that the embodiments are not limited to PLC and OFDM. The communication apparatus and communication method of the present invention can be applied to, for example, wavelet transformation techniques or various communication standards such as DSL, Ethernet, and wireless LANs.

Furthermore, the elements of the communication apparatus and processing steps in the above embodiments can be realized by a processing means, such as a CPU, executing programs stored in a storage means, such as a ROM or RAM, and controlling a communication means, such as an interface circuit. Therefore, a computer that has these means can realize the various functions and various processes of the communication apparatus according to the embodiments of the present invention simply by reading a recording medium on which is recorded the stated program and executing that program. Furthermore, recording the stated program on a removable recording medium makes it possible for any computer to realize the above-mentioned various functions and various processes.

With respect to this recording medium, a memory (not shown), such as a ROM, used so that a microcomputer performs the processing, may be the program medium, or a program reading device (not shown), serving as an external storage medium into which the recording medium is inserted, may be provided as the readable program medium.

In any case, it is preferable for the stored program to be configured so as to be accessed by a microprocessor and executed. Furthermore, it is preferable for the program to employ a method whereby the program is read out, the read-out program is downloaded into a program storage area in the microcomputer, and the program is executed. Note that this program for downloading is assumed to be stored in the apparatus itself in advance.

Furthermore, the stated program medium is a recording medium that is configured to be removable from the apparatus itself and that holds the program in a fixed state, as in tape systems such as magnetic tape, cassette tapes, and so on; magnetic disks such as flexible disks, hard disks, and the like, or disk systems such as CDs/MOs/MDs/DVDs and so on; card systems such as IC cards (including memory cards); or semiconductor memories that employ mask ROMs, EPROMs, EEPROMs, flash ROMs, and so on.

Furthermore, if the system configuration allows connection to a communication network, including the Internet, it is preferable for the recording medium to hold the program in a mobile state, so that the program is downloaded from the communication network.

Moreover, when the program is downloaded from a communication network in such a manner, it is preferable to store a program for downloading in the apparatus itself in advance or to be installed from a separate recording medium.

The present invention can be carried out in other various forms without departing from the spirit or essential characteristics thereof. The above embodiments are therefore to be taken in all respects as exemplary only, and are not to be interpreted as being limiting. The present invention is represented by the appended claims and is not restricted in any way to the specification itself. Furthermore, all variations and modifications falling within the scope of the claims also fall within the scope of the present invention.

This application claims the benefit of JP 2007-105099A, filed in Japan on Apr. 12, 2007, the content of which is incorporated herein in its entirety.

### INDUSTRIAL APPLICABILITY

The present invention can be applied in a communication apparatus, communication method, and communication program that require high-speed channel changes and high-speed channel estimation, and in a recording medium on which the communication program is recorded.

1. A communication apparatus comprising:
a communication means that at least receives a packet;
a detection means that detects information, contained in the packet, that is known to both transmitting-side and receiving-side communication apparatuses;
a comparison means that compares multiple pieces of the known information detected by the detection means; and
a channel estimation means,
wherein a channel estimation start instruction is given to the channel estimation means based on a result of the comparison performed by the comparison means.

2. A communication apparatus comprising:
a communication means that sends and receives a packet;
a detection means that detects information, contained in the packet, that is known to both transmitting-side and receiving-side communication apparatuses;
a comparison means that compares multiple pieces of the known information detected by the detection means; and
a channel estimation means,
wherein, based on a result of the comparison performed by the comparison means, a channel estimation packet send request is made to a communication apparatus that sent the packet via the communication means and a channel estimation start instruction is given to the channel estimation means.

3. The communication apparatus according to claim 1, wherein the channel estimation start instruction is given in the case where the comparison means has determined that the multiple pieces of known information are different.

4. The communication apparatus according to claim 2, wherein the channel estimation packet send request is made and the channel estimation start instruction is given in the case where the comparison means has determined that the multiple pieces of known information are different.

5. The communication apparatus according to claim 3, wherein the comparison means determines that the multiple pieces of known information are different in the case where total of absolute values of differences between the multiple pieces of known information for each carrier is greater than a pre-set reference threshold.

6. The communication apparatus according to claim 3, wherein the comparison means determines that the multiple pieces of known information are different in the case where an absolute value of differences between the multiple pieces of known information in each of an arbitrary number of carriers is greater than a pre-set reference threshold.

7. The communication apparatus according to claim 2, wherein the channel estimation means performs channel estimation using the channel estimation packet that has been sent.

8. The communication apparatus according to claim 1, further comprising:
an identification means that identifies a communication apparatus that sent the packet,
wherein the comparison means compares the multiple pieces of known information sent by the same communication apparatus based on a result of the identification performed by the identification means.

9. The communication apparatus according to claim 8, wherein the identification means identifies the sending communication apparatus based on a transmitting terminal identifier contained in the packet.

10. The communication apparatus according to claim 8, wherein in the case where the communication means carries out communication using a cyclical channel access method, the identification means identifies packets received in the same time slot of the cycle as packets sent by the same communication apparatus.

11. A communication method for a receiving-side communication apparatus in a communication system that sends multiple packets from a transmitting-side communication apparatus to the receiving-side communication apparatus using multiple communication channels, the method comprising:
a detection step of detecting information, contained in the packet, that is known to both of the communication apparatuses;
a comparison step of comparing multiple pieces of the known information detected in the detection step; and
a step of giving a channel estimation start instruction to a channel estimation means based on a result of the comparison performed in the comparison step.

12. A communication method for a receiving-side communication apparatus in a communication system that sends multiple packets from a transmitting-side communication apparatus to the receiving-side communication apparatus using multiple communication channels, the method comprising:
a detection step of detecting information, contained in the packet, that is known to both of the communication apparatuses;
a comparison step of comparing multiple pieces of the known information detected in the detection step;
a step of making a channel estimation packet send request to a transmitting-side communication apparatus that sent the packet in the case where it has been determined that the multiple pieces of known information are different as a result of the comparison performed in the comparison step; and
a step of giving a channel estimation start instruction to a channel estimation means,
wherein the channel estimation means performs channel estimation using the channel estimation packet sent from the transmitting-side communication apparatus.

13. The communication method according to claim 11, further comprising:
an identification step of identifying the transmitting-side communication apparatus that sent the packet,
wherein the comparison step compares the multiple pieces of known information sent by the same communication apparatus based on a result of the identification performed in the identification step.

14. The communication method according to claim 13, wherein the identification step identifies a transmitting communication apparatus based on a transmitting terminal identifier contained in the packet.

15. The communication method according to claim 13, wherein in the case where the communication method carries out communication using a cyclical channel access method, the identification step identifies packets received in the same time slot of the cycle as packets sent by the same communication apparatus.

16. A communication program that causes a computer to execute the steps of the communication method according to claim 11.

17. A computer-readable recording medium on which is recorded the communication program according to claim 16.

18. The communication apparatus according to claim 4, wherein the comparison means determines that the multiple pieces of known information are different in the case where total of absolute values of differences between the multiple pieces of known information for each carrier is greater than a pre-set reference threshold.

19. The communication apparatus according to claim 4, wherein the comparison means determines that the multiple pieces of known information are different in the case where an absolute value of differences between the multiple pieces of known information in each of an arbitrary number of carriers is greater than a pre-set reference threshold.

20. The communication apparatus according to claim 4, wherein the channel estimation means performs channel estimation using the channel estimation packet that has been sent.
